(19) United States
(12) Patent Application Publication
(10) Pub. No.: US 2004/0124351 A1
(43) Pub. Date: Jul. 1, 2004

(54) Method for calibration of time-of-flight mass spectrometers

(76) Inventor: Fernando J Pineda, Baltimore, MD (US)

Correspondence Address: Francis A Cooch Office of Patent Counsel, The Johns Hopkins University, Applied Physics Laboratory, 11100 Johns Hopkins Road, Laurel, MD, 20723-6099, US

(21) Appl. No.: 10/380,025

(22) PCT Filed: Sep. 25, 2001
(86) PCT No.: PCT/US01/29995

(51) Int. Cl. H01J 49/00

(52) U.S. Cl. 250/288

(57) ABSTRACT

A method for calibrating time-of-flight mass spectrometers is provided. The method includes at least modeling a time-of-flight mass spectrometer as a composite operator in accordance with a state space approach. The model is used to perform both symbolic and numeric propagation. To perform symbolic propagation, the model is used to derive closed form equations for the time-of-flight, by symbolically propagating the state of one or more ions modeled as state vectors. To perform numeric propagation, the model is used to calculate the time-of-flight by numerically propagating the state vector representation of one or more ions.

### CROSS-REFERENCE TO RELATED APPLICATIONS

This application claims the benefit of prior filed, co-pending U.S. provisional application serial No. 60/235,655, filed on Sep. 26, 2000.

### BACKGROUND OF THE INVENTION

1. Field of the Invention

This invention relates generally to time-of-flight mass spectrometers, and more particularly, to a method for calibrating a time-of-flight mass spectrometer.

2. Description of the Related Art

Mass spectrometry is an analytical technique for accurate determination of molecular weights, the identification of chemical structures, the determination of the composition of mixtures, and qualitative elemental analysis. In operation, a mass spectrometer generates ions of sample molecules under investigation, separates the ions according to their mass-to-charge ratio, and measures the relative abundance of each ion.

Time-of-flight (TOF) mass spectrometers separate ions according to their mass-to-charge ratio by measuring the time it takes generated ions to travel to a detector. TOF mass spectrometers are advantageous because they are relatively simple, inexpensive instruments with virtually unlimited mass-to-charge ratio range. TOF mass spectrometers have potentially higher sensitivity than scanning instruments because they can record all the ions generated from each ionization event. TOF mass spectrometers are particularly useful for measuring the mass-to-charge ratio of large organic molecules where conventional magnetic field mass spectrometers lack sensitivity. The prior art technology of TOF mass spectrometers is shown, for example, in U.S. Pat. Nos. 5,045,694 and 5,160,840 specifically incorporated by reference herein.

Mass spectrometers require periodic external calibration or continual internal calibration as part of the standard operating procedure. The most commonly used calibration method assumes a simple quadratic relationship between the ion time-of-flight and its m/z ratio. This relationship is based on a simplified physical model of mass spectrometer dynamics. More advanced calibration methods are based on more detailed physical models of mass spectrometers. One such advanced calibration method is described in N. P. Christian, R. J. Arnold. and J. P. Reilly, “Improved calibration of time of flight mass spectra by simplex optimization of electrostatic ion calculations”, Anal. Chem. 72, 3327-2227 (2000). Although this improved calibration method is better than the simplest calibration method, it has inherent disadvantages. For example, the different geometry of each instrument means that the manufacturer must tediously derive time-of-flight expressions for each different instrument and for each different operating condition. Another inherent disadvantage is the complexity of the resulting optimization algorithms which must either depend on tediously derived gradient expressions or which must make use of general purpose global optimization algorithms, e.g., simplex or stochastic gradient descent algorithms. A related problem is the inherent difficulty of including natural constraints such as the estimated measurement errors.

Accordingly, it would be desirable to provide an improved calibration method due to the aforementioned limitations.

### SUMMARY OF THE INVENTION

In accordance with the present invention improved, methods are provided for modeling and calibrating time-of-flight mass spectrometers. According to one aspect of the present invention, a mass spectrometer is modeled as a composite operator in accordance with a state space approach. In a state space approach an ion is represented as a vector of properties, e.g. position, momentum, mass and charge. The properties can be represented numerically as a set of values or symbolically as a set of variables. Propagation of ions through a mass spectrometer can be represented either numerically or symbolically. In the former case actual values of ion properties are calculated for each stage in the mass spectrometer. In the latter case, symbolic expressions for the properties are automatically generated at each stage in the mass spectrometer. These expressions can be numerically evaluated, if desired, to recover the numerically propagated values. In the case of simulation, numerical propagation provides an exceptionally efficient alternative to numerically integrating the equations of motion as performed in the prior art. In the case of calibration, numerical propagation is combined with a dynamic programming approach to yield a novel calibration and optimization algorithm which may be used to calibrate the mass spectrometer. In the case of analysis and design, symbolic propagation provides an exceptionally simple way of deriving mathematical expressions, such as time-of-flight equations and n-th order focusing relationships.

According to one aspect, to perform either symbolic or numeric propagation, a mass spectrometer is first modeled as multi-stage or composite operator where each stage represents one element or process of the spectrometer. Ion transport through the spectrometer corresponds to the sequential application of operators, where each operator performs a nonlinear state transition on the state of the ion from the preceding stage. State transitions represent physical phenomena, e.g., desorption, entrainment, propagation, drift and detection.

In accordance with one aspect of the invention, a method for deriving an analytic (i.e. symbolic) expression for the time-of-flight generally includes the steps of: representing an ion as a symbolic state vector; modeling the mass spectrometer as a sequence of nonlinear operators; and symbolically propagating the symbolic state vector through the sequence of nonlinear operators to derive a final state vector. The said time-of-flight expression is the time-component of the final state vector.

In accordance with another aspect of the invention a method for simulating the propagation of millions of ions to produce simulated spectra is performed by numerically propagating the state of millions of ions. Numerical propagation by nonlinear operators in the space is performed in lieu of numerical propagation by numerical integration methods such as Runge-Kutta methods.

According to another aspect of the invention, a method for calibrating a mass spectrometer via numerical propagation generally includes the steps of: modeling an ion as a numerical multi-dimensional state vector; modeling the mass spectrometer as a sequence of operators; numerically propagating the numerical state vector through the mass spectrometer model to calculate a pre-defined error function. In accordance with the calibration method, the numerical propagation of a state vectors is combined with the backward propagation of adjoint vectors, in a dynamic programming approach, to produce a numerically efficient calibration and optimization algorithm.

One benefit obtained by the use of the present invention is a simulation method which models time-of-flight mass spectrometers without the necessity of having to numerically integrate the equations of motion with, e.g., Runge-Kutta methods.

Another benefit obtained from the present invention is the ease with which the modeling method can be applied to a wide variety of time-of-flight mass spectrometers by simply modifying one or more of the constituent operators in accordance with the design of the device. Thus, the modeling software can simulate a wide range of mass spectrometer designs. Different mass spectrometer geometries and configurations can be handled by simply changing an input file that specifies the sequence of operators and their parameters.

An associated advantage of the present invention is the ability to easily derive analytical expressions for the time-of-flight. This also makes it easy to calculate the sensitivity of the time-of-flight with respect to the various system parameters and initial states. This is useful for mass spectrometer design tasks such as estimating design parameters for n-order focusing.

Yet another benefit of the present invention is that parameter estimation for performing calibration may be based on well known techniques of dynamic programming.

Other benefits and advantages for the present invention will become apparent to those skilled in the art upon the reading and understanding of this specification.

### BRIEF DESCRIPTION OF THE DRAWING

FIG. 1 is an illustration of an exemplary state-space model of a mass spectrometer in accordance with one embodiment of the invention;

### DESCRIPTION OF THE PREFERRED EMBODIMENTS

The state-space approach is based on the representation of ions as a state vector representing the various ion properties. The state space model is used to (1) derive a closed form equation for the time-of-flight and, (2) simulate, calibrate, and optimize the mass spectrometer. State space representations are completely general, but an exemplary 5-dimensional state vector is used to farther clarify the invention. Accordingly, to represent an ion we first neglect its internal degrees of freedom. Four of the five dimensions correspond to a mechanical phase space. The zero-th coordinate is the charge, q, of the ion. In the exemplary embodiment, the phase space has two coordinate dimension (time and position along the axial direction) and two momentum dimensions (energy and momentum along the axial direction). Since the ions in a MALDI-TOF instrument are non-relativistic, the kinetic energy of the ion is negligible and the energy component is well approximated by the rest mass of the ion. Thus the ion vector is a 5-component vector of the form

$$x = ( \begin{matrix}q \\ m \\ p \\ t \\ z\end{matrix} ) .$$

Ions are propagated either numerically or symbolically through each stage of the spectrometer by nonlinear operators. The ion state vector at each stage is labeled by the superscript s. the initial state is represented by x⁰ while the final state of an N stage spectrometer is represented by state x_{N}. The state of the ion at stage s,x^{s} is determined from the state of the ion in the previous stage x^{s-1} via a nonlinear transformation performed by the operator stage s.

x^{s}=m^{s-1}(θ^{s-1}, x^{s-1})

Where θ^{s-1s-1} represents the parameters of the operator M^{s-1} at stage s-1.

A listing of some representative operators that may be used in the state space model of the present invention are described in Table I.

TABLE I

| OPERATOR AND | | |
|---|---|---|
| ASSOCIATED | PARAMETER | OPERATOR |
| PARAMETERS | DESCRIPTIONS | DESCRIPTIONS |
| P(q, x) | charge (q) | Protonation (P) |
| Mₑₙₜ(v_{o, x}) | initial velocity (v_{α}) | Entrainment (Mₑₙₜ) |
| M_{driftt}(l, x) | drift length (l) | Drift (M_{drift}) |
| M_{acc}(l, V, x) | length (l), voltage drp (V) | Acceleration (M_{acc}) |
| Mᵢₘₚᵤₗₛₑ(V, x) | voltage drop (V) | Impulse (Mᵢₘₚᵤₗₛₑ) |
| M_{delEx}(l, V, τx) | length (l), voltage drop (V), | Delayed extraction |
| | delay (τ) | |

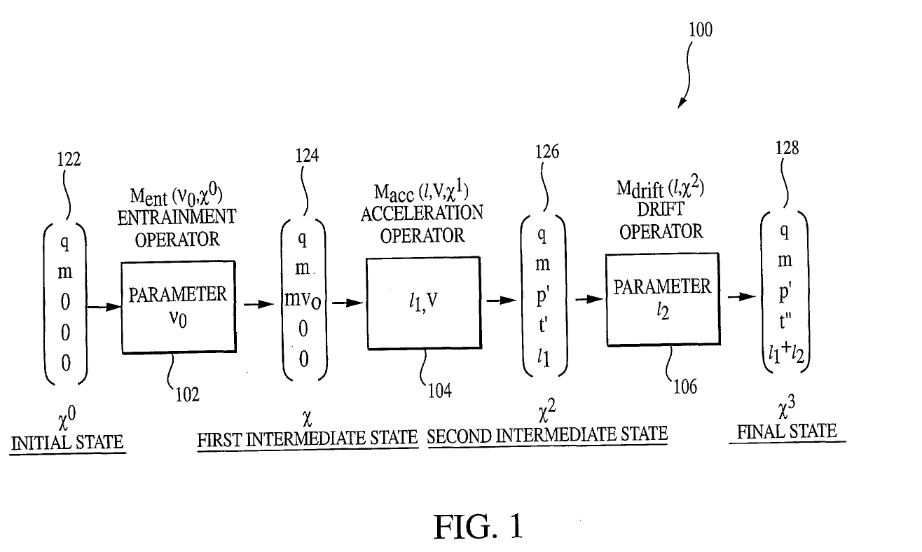

Table I identifies typical operators used to construct a state space model and their associated operators, three of which are incorporated in the exemplary state space model 100 of FIG. 1. It should be understood however that other operators different than those shown in Table I can also be implemented. The forms for each of the six operators described in Table I are derived in Appendix A.

FIG. 1 shows, in simplified form, an exemplary state space model 100 of a mass spectrometer. Specifically shown in FIG. 1 is an exemplary mass spectrometer model 100 consisting of a sequence of 3 operators (stages) {e.g., Mₑₙₜ102, M_{acc}104, M_{drift}106} where each operator or stage 102-106 propagates a state vector representation of an ion by performing a nonlinear transformation on the state of the ion. For example, operator 102 propagates ion state vector 122, operator 104 propagates state vector 124 and operator or stage 106 state vector 126.

Three embodiments will be described hereinbelow. A first embodiment describes the symbolic propagation of ion states. A second embodiment describes numerical propagation of ion states. This includes the description of numerical propagation for simulation. A third embodiment describes how numerical forward propagation and numerical backward propagation are combined to construct a dynamic programming algorithm for efficient mass spectrometer calibration.

I. Symbolic Propagation

The mathematical detailing of the present invention for deriving a closed form time-of-flight expression according to a first aspect is now described. More particularly, a symbolic propagation of a symbolic state vector representation of an ion through the state-space model 100 of FIG. 1 is described in accordance with the symbolic propagation method utilizing the illustrative model of FIG. 1.

The state space model of the present invention is advantageous in that it can be flexibly applied to a wide variety of time-of-flight spectrometers by selecting only those operators which define the specific operations of the spectrometer to be modeled.

With continued reference to FIG. 1, the illustrative state space model 100 is shown as consisting of three stages, where each stage represents a particular operation of the spectrometer. In the illustrative state-space model 100, the first stage or operator is referred to as an entrainment operator Mₑₙₜ(v₀,x) having a single parameter, velocity. The second stage is referred to as an acceleration operator M_{acc}(l, V,x) having two parameters representing the propagation of the ion through a region of length l₁ and through a voltage drop V respectively. The third and final stage is referred to as a drift operator M_{drift}(l,x), which represents the drift of an ion through a region of length l₁ with zero electric field. The final state, x³ 128, of the ion state vector, upon exiting the spectrometer is determined from the previous state x² via the nonlinear transformation performed by the drift operator M_{drift}(l,x). For example, a program (written in the MATHEMATICA™ programming language that performs these transformations is

| | | |
|---|---|---|
| I. | TOF[{q_,m_,p_,t_z_}] | :=t; |
| II. | Ment[v0_,{q_,M_,p_,t_,z_}] | :={q,m,p+m*v0,t,z}; |
| III. | Mdrft[L_,{q_,m_,p_,t_,z_}] | :={q,m,p,t+m*L/p,z+L}; |

| | |
|---|---|
| IV. | Macc[L_,V_,{q_,m_,p_,t_,z_}] |
| | :={q,m,Sqrt[2*m*(q*V)+Sgn[p]*p\hat{ }2], |
| | 1. t+L*(Sqrt[2*m*(q*V)+p\hat{ }2]− |
| | p)/(q*V),z+L}; |
| V. | x0 = {q,m,ppp}; |
| VI. | TOF[Mdrft[L2,Macc[L1,V,Ment[v0,x0]]]] |

Output of this program is the expression for the time-of-flight for an ion propagated through the model spectrometer in FIG. 1.

$${t}^{″} = \frac{m {l}_{2}}{\sqrt{2 mqV + sgn ( {ν}_{o} ) {( {mv}_{o} )}^{2}}} + \frac{{l}_{1}}{qV} \{ {mv}_{0} - \sqrt{2 mqV + {( {mv}_{o} )}^{2}} \} \qquad ( 2 )$$

To summarize, the symbolic propagation approach allows for a mechanical derivation of closed form equations for the time-of-flight, by symbolically propagating the state of the ion is performed. This is accomplished by symbolically propagating the state of the ion in symbolic manipulation software such as MATHEMATICA™, MAPLE™ or MACSYMA™. The time component of the resulting final state is the desired closed from equation for the time-of-flight.

II. Numerical Propagation

A numerical propagation approach for simulating ion propagation in mass spectrometers to perform calibration and/or simulation and for calibration.

In the numerical propagation approach, numerical values are used instead of symbolic expression, for the coordinates of the state vectors. The numerical values of the state vector are operated on by the operators of the model the end result of which is a vector containing numerical values for the final ion properties. It is noted that in accordance with the numerical propagation approach, a time-of-flight expression is never derived.

II.a. Simulation

Simulation of mass spectrometers is essential for interpreting mass spectra and for understanding the physics of mass spectrometers. For example, simulation is a means of predicting peak shapes and the effect of stochastic phenomena on peak shape.

The numerical propagation of state vectors by nonlinear operators is an efficient means of simulating mass spectrometers. In particular, this approach is more efficient than Runge-Kutta integration of equations of motion. The operator approach can be made to approximate numerical integration to arbitrary precision, by simply dividing up a mass spectrometer geometry into small segments, each of which is represented by a single nonlinear operator.

In the case of a one dimensional mass spectrometer model composed of an acceleration region and a flight tube, (e.g. FIG. 1) it is possible to simulate the flight of millions of ions in just a few seconds of cpu time on a conventional desktop computer (e.g., a 350 Mhz Apple G3).

The numerical propagation approach for performing calibration of a mass spectrometer generally includes the steps of:

A first step, step (1), involves representing the ion as a multi-dimensional numerical state vector. For example, referring to state vector x⁰ in FIG. 1, the ion could, for example, be represented as a state vector having five coordinates where each coordinate contains a numerical value representing: the initial charge on the ion (q), the mass of the ion (m), the momentum (p), along the axial direction, the time (t), and position (z), respectively along the axial direction. It is noted that numerical values are used for each coordinate position in contrast to the closed form expressions used in the symbolic propagation approach.

The second step, step (2), involves numerically propagating the numerical state vector as constructed in step (1) through the sequence of operators of the state model 100. As this is done it is required to save the intermediate ion state vectors along the way.

II.a. Calibration

Numerical propagation may be used to perform calibration. In general, the objective of mass spectrometer calibration is to minimize the error between an observed time-of-flight tᵢ and a predicted time-of-flight xᵢⁿ, subject to regularization constraints that account for measurement errors and other uncertainties in the model parameters. A dynamic programming approach is now described for performing mass spectrometer calibration.

The dynamic programming approach for performing calibration of a mass spectrometer generally includes the steps of:

A first step, step (1), involves representing calibrant ion with known masses as multi-dimensional numerical state vector. For example, referring to state vector x⁰ in FIG. 1, the ion could, for example, be represented as a state vector having five coordinates where each coordinate contains a numerical value representing: the initial charge on the ion (q), the mass of the ion (m), the momentum (p), along the axial direction, the time (t), and position (z), respectively along the axial direction.

The second step, step (2), involves numerically propagating each numerical state vector as constructed in step (1) through the sequence of operators of the mass spectrometer model 100. As this is done it is required to save the intermediate ion state vectors along the way.

The third step, step (3), involves deriving an error function which computes an adjoint vector computed as the difference between the predicted (i.e., final) state vector and a partially observed state vector. The adjoint vector, depends on the particular error function used to define the difference between the observed and predicted state vector.

The fourth step, step (4), involves taking the error state vector from step (3) and propagating it backward through the mass spectrometer model 100 using a set of backward operators to calculate a backward error vector at each intermediate stage all the way back to the initial stage. The backward error vectors at each intermediate stage are saved as they are calculated.

It is noted that for every forward operator in the mass spectrometer model 100 there is an associated backward operator. The backward operators are a function of both the form of the forward operator and the state vector at that intermediate storage. At this point, at each stage of the model there is an associated forward state vector and backward error vector.

The fifth step, step (5), involves combining the N intermediate state vectors with the N intermediate adjoint vectors to update at least one parameter, θ, to minimize the derived error function.

The pseudo-code of Table II below which describes the dynamic programming algorithm for calibration in more detail. Dynamic programming techniques are well-known in the art but have not been applied to the problem of mass spectrometer calibration.

TABLE II
Pseudocode

| | | |
|---|---|---|
| 1. | While (\|Δθ\| < ε ) { | // iterate until parameter updates are |
| | sufficiently small | |

| | |
|---|---|
| I. | for(s=1 to N) Δθ^{s} = 0 // zero out the weight updates |
| II. | for(each ion i) { |

1. // forward propagation --------------------
2. set mᵢ and qᵢ in x^{o}
3. for(s = 1 to N)

| | |
|---|---|
| 2. | x^{s} = M^{s-1}(θ^{s-1},x^{s-1}) |

1. // backward propagation

| | |
|---|---|
| 3. | ${δ}_{k}^{N} = \{ \begin{matrix}{\sum }_{i = 1}^{n} ( {t}_{i} - {x}_{i}^{N} ) & if k = time & \\ & & // initialize adjoint \\ 0 & otherwise & \end{matrix}$ |

vector

a. for(s = 1 to N) }

| | |
|---|---|
| 4. | ${J}_{kj}^{s + 1} = \frac{\partial {x}_{k}^{s + 1}}{\partial {x}_{j}^{s}} \qquad // adjoint matrix$ |
| 5. | ${δ}_{k}^{s} = {\sum }_{k} {δ}_{k}^{s + 1} {J}_{kj}^{s + 1} \qquad // backpropagate adjoint vector$ |

a. }

2. // update parameters --------------------

a. for(s = 1 to N) }

| 6. | | ${L}_{j}^{s} = \frac{\partial {g}^{s} ( {θ}^{s} )}{\partial {θ}_{j}^{s}}$ |
|---|---|---|
| | i. | ${K}_{kj}^{s + 1} = \frac{\partial {x}_{k}^{s + 1}}{\partial {θ}_{j}^{s}}$ |
| | ii. | ${Δθ}_{j}^{s} = {Δθ}_{j}^{s} - \{ {\sum }_{k} {δ}_{k}^{s + 1} {K}_{kj}^{s + 1} + {L}_{j}^{s} \} // accumulate gradient$ |

b. }

| | |
|---|---|
| II. | } // end ion loop |
| III. | for(s=1 to N) } |

| | | |
|---|---|---|
| IV. | ${θ}_{j}^{s} = {θ}_{j}^{s} + {ηΔθ}_{j}^{s}$ | // update the |

| | parameters |
|---|---|
| V. | } |

| | |
|---|---|
| 7. | } |

The right hand side of the expression uses the previously computed backward error vectors in addition to forward propagation vectors K and L. The expression explicitly illustrates the dependence of the change in parameter values as a function of the intermediate backward error vectors. The intermediate state vectors which are saved during forward propagation are used to calculate the K and L matrices which are needed to accumulate the gradient of the error function with respect to the model parameters.

Successive iteration of the main loop in the pseudo-code are run. In each iteration the parameters of each operator are modified in accordance with the change specified by the values from the previous iteration. At some point, the delta values will not undergo a significant change from the previous iteration. At that point the parameter values are considered to be optimum values thereby completing the calibration procedure.

While several embodiments of the present invention have been shown and described, it is to be understood that many changes and modifications may be made thereto without departing from the spirit and scope of the invention as defined in the appended claims.

Appendix A. Selected Operators

Here, I derive the form of various useful operators.

1) P(Q,.)—The protonation operator updates the charge by an amount Q(where Q is a signed integer). The mass is updated by an amount Qmₚ where mₚ is the proton rest mass.

$$P ( Q , x ) ≡ ( \begin{matrix}q + Q \\ m + {Qm}_{p} \\ p \\ t \\ z\end{matrix} ) .$$

2)Mₑₙₜ(v₀)—In general, ablation/desorption operators are stochastic operators that describe the entrainment of analyte ions in the plume. There is a lot of latitude in their definition. The simplest entrainment operator is deterministic. The current code has a very simple idealized ablation/desorption operator which always operators on the initial state, x⁽⁰⁾ and occurs in zero time, Δt=0, across zero length Δz=0. Thus we have

$${M}_{ent} ( {ν}_{0} , x ) ≡ ( \begin{matrix}q \\ m \\ {mv}_{0} \\ 0 \\ 0\end{matrix} ) ,$$

where v₀, is a deviate drawn from an empirical velocity distribution of ejected molecules [Zhigilei and Garrison, 1997]. The distribution has two parameters corresponding to a temperature of 400 K for matrix and analyte molecules and a maximum stream velocity of uₘₐₓ=65×10³ cm/s [Zhigilei and Garrison, 1998].

3)M_{drift}(l.,)—A drift operator propagates an ion through a region of length l with zero electric field. A drift operator only has one parameter. This is the length, l, of the drift region. Thus there is no change in the momentum. Only the coordinates change. The position component changes by the length of the drift region. The time transforms simply by the amount of time it takes an ion with constant velocity to cross a distance l,

$${M}_{drift} ( l , x ) ≡ ( \begin{matrix}q \\ m \\ p \\ t + ml / p \\ z + l\end{matrix} )$$

4) M_{acc}(l, V,.)—An acceleration operator propagates an ion through a region of length l with nonzero axial electric field. An acceleration operator has two parameters. These are the length, l of the region and V, the potential drop across the region. Thus V is positive if the potential decreases from left to right, and is negative otherwise. The acceleration operator has the form

$${M}_{acc} ( l , V , x ) ≡ ( \begin{matrix}q \\ m \\ {p}^{′} \\ t + Δ t \\ z + sgn ( p ) l\end{matrix} )$$

where p′=\sqrt{2mqV+sgn(p)p²} follows from conservation of energy. The time interval, Δt, it takes to traverse the distance l is derived as follows. First, express l, in terms of the acceleration, a, the initial velocity, v, and the time interval, Δt. The result is l=vΔt+a(Δt)²/2. Solving this for Δt yields,

$$Δ t = \frac{\sqrt{{v}^{2} + 2 al} - v}{a} .$$

But the acceleration is a=qV/ml and the initial momentum is p=mv. After a little algebra, this yields the desired expression

$$Δ t = \frac{1}{qV} \{ \sqrt{2 mqV + {p}^{2}} - p \} .$$

This expression assumes that p²/2m+qV>0. The case where p²/2m+qV<0 corresponds to a reflectron. Note that the acceleration operator reduces to the drift operator in the qV→0 limit.

5) Mᵢₘₚᵤₗₛₑ(V,.)—An impulse operator is a useful idealization. It represents propagation through a finite voltage drop across a zero-length interval. In other words, one ignores propagation through the extraction region. The ion receives an instantaneous kick that updates it's momentum,

$${M}_{impulse} ( V , x ) ≡ ( \begin{matrix}q \\ m \\ {p}^{′} \\ t \\ z\end{matrix} )$$

where p′=\sqrt{2mqV+sgn(p)p²}. The impulse operator is an unphysical limiting case of the acceleration operation. We formalize it here because it yields the standard expressions found in many text books [e.g. Robert J. Cotter, Time-of-flight Mass Spectrometry, American Chemical Society, 1997]

6) Extraction/desorption operator—It is useful to define an extraction/desorption operator as a composite operator that describes a phenomenological extraction and desorption process,

M_{desb}(l,v₀,t₀,V,.)≡M_{acc}(l−v₀,t₀,V′,P(q,M_{drift}(v₀t₀,Mₑₙₜ(v₀),.))).

From right to left we have entrainment with velocity v₀, followed by drift of the neutral molecule through a length v₀t₀ in the extraction region. The particle is ionized at time t₀ and picks up a charge q. Finally, the ion is accelerated though the remaining length l−v₀t₀ of the extraction region through the remaining voltage drop

$${V}^{′} = V \cdot ( 1 - \frac{{v}_{0} {t}_{0}}{l} ) .$$

7) Delayed extraction operator—Delayed extraction is a composite operator. In this operator we assume the ion has been entrained and protonated before the high voltage is turned on, been entrained with a velocity p/m=v₀. Thus the operator consists of an initial drift followed by an acceleration

M_{delEx}(l,v₀,τ,V,.)=M_{acc}(l−pτ/m,V,M_{drift}(pτ/m,.)).

Where

$${V}^{′} = V \cdot ( 1 - \frac{p τ}{l m} ) .$$

What is claimed:

1. A method for calibrating a time-of-flight mass spectrometer, said method comprising the steps of:
modeling an ion as a numerical multi-dimensional state vector;
modeling the mass spectrometer as a composite operator model wherein said model comprises a sequence of nonlinear operators; and
numerically propagating the numerical multi-dimensional state vector through the sequence of nonlinear operators to a calculated final state; and
minimizing an error function.

2. The method of claim 1 wherein the step of minimizing an error function further comprises the step of minimizing the error function via a dynamic programming algorithm.

3. The method of claim 1 wherein the error function is based on a measured discrepancy between the calibrated final state and a partial observation of an actual final state.

4. The method of claim 1 wherein the step of numerically propagating the state vector through the model further comprises the steps of:
numerically forward propagating the multi-dimensional state vector through the sequence of N mathematical forward operators to generate N intermediate state vectors; and
numerically backward propagating an adjoint vector backwards through the sequence of N mathematical adjoint operators to generate N intermediate-state adjoint vector.

5. The method of claim 1 wherein the minimizing step further comprises the step of combining the N intermediate-state vectors and final-state adjoint vectors to minimize an error function.

6. A method for calibrating a time-of-flight mass spectrometer, said method comprising the steps of:
modeling an ion as a multi-dimensional numerical initial state vector in a form usable by a computing device;
modeling the mass spectrometer as a sequence of N mathematical forward operators in a form usable by the computing device where each of said forward operators has none or one or more associated parameters;
numerically propagating the numerical initial state vector through the N mathematical forward operators to generate N-1 numerical intermediate-state vectors and a numerical final-state vector;
computing, via a pre-defined error function, an adjoint vector as a function of the numerical final-state vector and a partially observed state vector;
numerically propagating the adjoint vector backwards through a sequence of N mathematical adjoint operators to generate N intermediate-state adjoint vectors; and
combining the N intermediate-state vectors with the N intermediate-state adjoint vectors to update the one or more parameters to minimize the pre-defined error function.

7. The method of claim 6 wherein the step of numerically propagating the numerical initial state vector further comprises the step of performing a non-linear transformation on one of the initial state vectors, the N-1 intermediate state vectors, and the numerical final-state vector by one of the N mathematical forward operators.

8. The method of claim 6 wherein the N mathematical forward operators collectively define a corresponding sequence of physical operations performed by the mass spectrometer.

9. The method of claim 6 wherein the N mathematical forward operators can be one a stochastic operator and a deterministic operator.

10. A method of deriving a time-of-flight expression for a time-of-flight mass spectrometer, said method comprising the steps of:
modeling an ion as a multi-dimensional symbolic ion state vector;
modeling the mass spectrometer as a sequence of N mathematical forward operators; and
symbolically propagating the numerical ion state vector through the N mathematical operators to derive said time-of-flight expression.

11. A system for calibrating a time-of-flight mass spectrometer comprising:
means for modeling an ion as a numerical multi-dimensional state vector;
means for modeling the mass spectrometer as a composite operator model wherein said model comprises a sequence of nonlinear operators; and
means for numerically propagating the numerical multi-dimensional state vector through the sequence of nonlinear operators to a calculated final state; and
means for minimizing an error function.

12. The system of claim 11 further comprising:
means for minimizing any error function further comprises the step of minimizing the error function via a dynamic programming algorithm wherein the error function is based on a measured discrepancy between the calibrated final state and a partial observation of an actual final state.
